(19) United States
(12) Patent Application Publication
(10) Pub. No.: US 2017/0146930 A1
(43) Pub. Date: May 25, 2017

(54) DEVELOPING APPARATUS

(71) Applicant: CANON KABUSHIKI KAISHA, Tokyo (JP)

(72) Inventors: Shunichi Takada, Soka-shi (JP); Tomohito Ishida, Suntou-gun (JP); Kenta Kubo, Kamakura-shi (JP); Koichi Hashimoto, Yokohama-shi (JP); Tatsuya Onishi, Yokohama-shi (JP)

(21) Appl. No.: 15/351,658

(22) Filed: Nov. 15, 2016

(30) Foreign Application Priority Data
Nov. 20, 2015 (JP) 2015-227262

(51) Int. Cl. G03G 15/09

(52) U.S. Cl. CPC G03G 15/0921

(57) ABSTRACT

A developing apparatus of the present disclosure includes a developing sleeve including a plurality of magnetic substance portions bearing, on a surface thereof, developer containing toner and carrier and conveying the developer to a developing area facing a photosensitive drum, and a magnet roller disposed within the developing sleeve and generating magnetic fluxes passing through the magnetic substance portion. The magnetic substance portion includes, on an end surface thereof, a high flux density portion disposed at least one of upstream and downstream parts in a conveyance direction of the developing sleeve and through which the magnetic fluxes pass and a low flux density portion through which the magnetic fluxes whose density is lower than the magnetic fluxes passing through the high flux density portion pass.

### BACKGROUND OF THE INVENTION

Field of the Invention

The present disclosure relates to a developing apparatus for use in an image forming apparatus adopting such a system that an electro-photographic system and electro-static recording system.

Description of the Related Art

Hitherto, an electro-photographic image forming apparatus is configured to visualize an image by developing an electrostatic latent image formed on an image bearing member such as a photosensitive drum by applying resin or the like containing coloring matters and others. Among the conventional developing apparatuses used in such development, a developing apparatus using a two-component developer (referred to simply as ‘developer’ hereinafter) containing toner and carrier as developer is widespread.

In the developing apparatus using the developer, the developer forms a brush shape (referred to as a ‘magnetic brush’ hereinafter) by a magnet disposed within a developer bearing member (referred to simply as a ‘developing sleeve’ hereinafter) in a developing area in which the image bearing member face the developing sleeve. In conveying the magnetic brush in the developing area, there is a case when the magnetic brush slips from the developing sleeve and is unable to follow rotations of the developing sleeve, thus causing a conveyance failure of the developer. Such developer conveyance failure may lead to a decrease of a toner quantity to be conveyed to the developing area or to a density unevenness, causing deterioration of density and unevenness of an image.

In order to solve the abovementioned problem, there is proposed a developing apparatus forming a magnetic substance layer on a developing sleeve and forming a magnetic brush starting from a carrier adsorbed by a magnetic force as disclosed in Japanese Patent Application Laid-open No. 2007-93705 for example. According to this developing apparatus, it is possible to improve followability of the magnetic brush to the rotation of the developing sleeve. It is noted that in the developing apparatus, the magnetic substance layer is formed at first on an entire surface of the developing sleeve and then an unnecessary part is removed by etching in forming the magnetic substance layer on the developing sleeve.

However, because the unnecessary part is removed by etching after forming the magnetic substance layer on the entire surface of the developing sleeve in forming the magnetic substance layer on the developing apparatus of Japanese Patent Application Laid-open No. 2007-93705 described above, an upper surface of the magnetic substance layer is flattened. Thereby, magnetic flux density generated from the magnetic substance layer is approximately uniformed and a force acting on the magnetic brush is approximately uniform on the upper surface of the magnetic substance layer, so that there is a possibility of causing a conveyance failure of the magnetic brush when a force in a rotation direction of the developing sleeve acts on the magnetic brush. The possibility of causing the conveyance failure of the magnetic brush is heightened lately in particular due to spheroidization of toner and others. Thus, there is a possibility of causing the deterioration of image density and the image unevenness.

### SUMMARY OF THE INVENTION

The present disclosure provides a developing apparatus capable of suppressing a conveyance failure of a magnetic brush from occurring along a rotation of a developer bearing member.

According to a first aspect of the present disclosure, a developing apparatus includes a developer bearing member including a plurality of magnetic substance portions bearing developer containing toner and carrier on an end surface thereof and conveying the developer to a developing area facing an image bearing member and a magnetic flux generating member disposed within the developer bearing member and generating magnetic fluxes passing through the magnetic substance portions. Each magnetic substance portion includes, on the end surface, a first portion disposed at least one of upstream and downstream parts in a conveyance direction of the developer bearing member and through which the magnetic fluxes pass and a second portion through which the magnetic fluxes whose density is lower than the magnetic fluxes passing through the first portion pass.

According to a second aspect of the present disclosure, a developing apparatus includes a developer bearing member comprising a plurality of magnetic substance portions configured to bear developer containing toner and carrier on an end surface thereof and to convey the developer to a developing area facing an image bearing member, a magnetic flux generating member disposed within the developer bearing member and configured to generate magnetic fluxes passing through each magnetic substance portion, and a first portion provided on the magnetic substance portion and projecting from the outer edge of the end surface.

Further features of the present invention will become apparent from the following description of exemplary embodiments with reference to the attached drawings.

### BRIEF DESCRIPTION OF THE DRAWINGS

FIG. 1 is a schematic diagram illustrating an outline of a configuration of an image forming apparatus of a first embodiment.

FIG. 2 is a schematic diagram illustrating an outline of a configuration of an image pickup device of the first embodiment.

FIG. 3A is a perspective view illustrating magnetic substance portions provided on a surface of a developing sleeve.

FIG. 3B is a section view of the magnetic substance portion illustrated in FIG. 3A.

FIG. 4A is a diagram illustrating lines of magnetic flux passing through the magnetic substance portion of the first embodiment.

FIG. 4B is an enlarged view of a high flux density part through which the lines of magnetic flux illustrated in FIG. 4A pass.

FIG. 4C is a diagram illustrating lines of magnetic flux passing through a magnetic substance portion of a first comparative example.

FIG. 5 is a schematic diagram illustrating states of magnetic brushes formed on the magnetic substance portions of the first embodiment.

FIG. 6 is a schematic diagram illustrating states of magnetic brushes formed on the magnetic substance portions of the first comparative example.

FIG. 7A illustrates a procedure for forming the magnetic substance portion on the surface of the developing sleeve of the first embodiment, in which a resist film is formed.

FIG. 7B illustrates a non-forming portion removing step.

FIG. 7C illustrates a plating step.

FIG. 7D illustrates a resist removing step.

FIG. 8A is a section view illustrating a magnetic substance portion of a second embodiment.

FIG. 8B illustrates lines of magnetic flux passing through the magnetic substance portion illustrated in FIG. 8A.

FIG. 9A illustrates a procedure for forming the magnetic substance portion on the surface of the developing sleeve of the second embodiment, in which a non-forming portion is removed.

FIG. 9B illustrates a plating step.

FIG. 9C illustrates a resist film forming step.

FIG. 9D illustrates a step of a non-forming portion removing process.

FIG. 9E illustrates an etching process.

FIG. 9F illustrates a resist removing step.

FIG. 10 is a schematic diagram illustrating a condition in which a magnetic brush is formed on a magnetic substance portion of a third embodiment.

### DESCRIPTION OF THE EMBODIMENTS

### First Embodiment

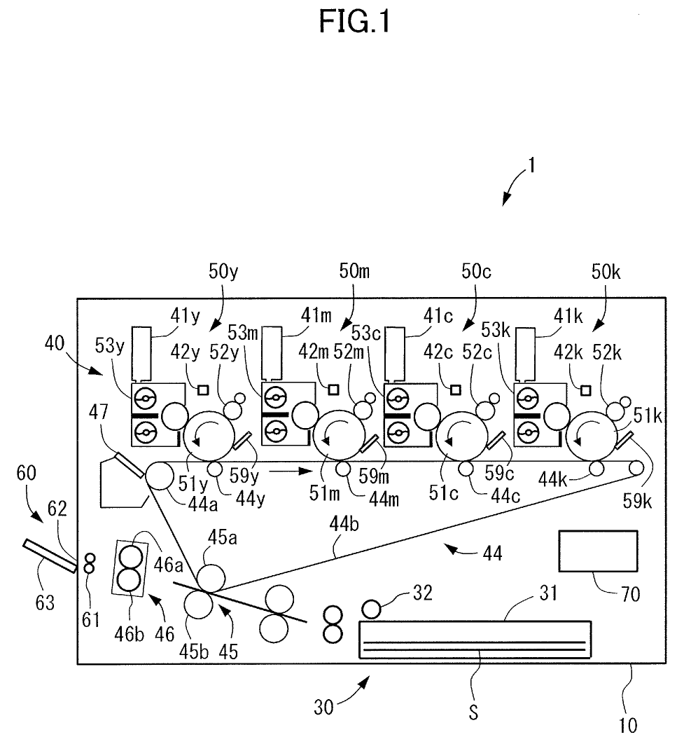

A developing apparatus of a first embodiment of the present disclosure will be described in detail below with reference to FIGS. 1 through 7. It is noted that a case when the developing apparatus is applied to a tandem type full-color printer, i.e., an exemplary image forming apparatus, will be described in the present embodiment.

However, the present disclosure is not limited to the developing apparatus of the tandem type image forming apparatus and may be a developing apparatus of another type image forming apparatus. The image forming apparatus is not also limited to be a full-color printer and may be a monochrome printer. The developing apparatus may be also carried out in various uses such as a printer, various printing machines, a copier, a facsimile, and a multi-function printer by adding necessary machines, attachments, and a case structure. Still further, the image forming apparatus 1 of the present embodiment is a type which includes an intermediate transfer belt, primarily transfers various color toner images onto the intermediate transfer belt, and then of secondarily transfers the composite toner image of the respective colors collectively onto a sheet of paper. However, the image forming apparatus is not limited to such type apparatus and may be a type of directly transferring a toner image from a photosensitive drum to a sheet of paper conveyed by a sheet conveyance belt.

As illustrated in FIG. 1, the image forming apparatus 1 includes an apparatus body 10, a sheet feed portion 30, an image forming portion 40, a sheet conveyance portion not illustrated, a sheet discharge portion 60, a control portion 70, and an operation portion not illustrated. It is noted that the sheet S, i.e., a recording medium, is what a toner image is formed thereon and may be a plain sheet of paper, a synthetic resin sheet, i.e., a substitute of the plain sheet, a thick sheet, an overhead projector sheet or the like for example.

The sheet feed portion 30 is disposed at a lower part of the apparatus body 10 and includes a sheet cassette 31 stacking and storing the sheet S and a feed roller 32 feeding the sheet S to the image forming portion 40.

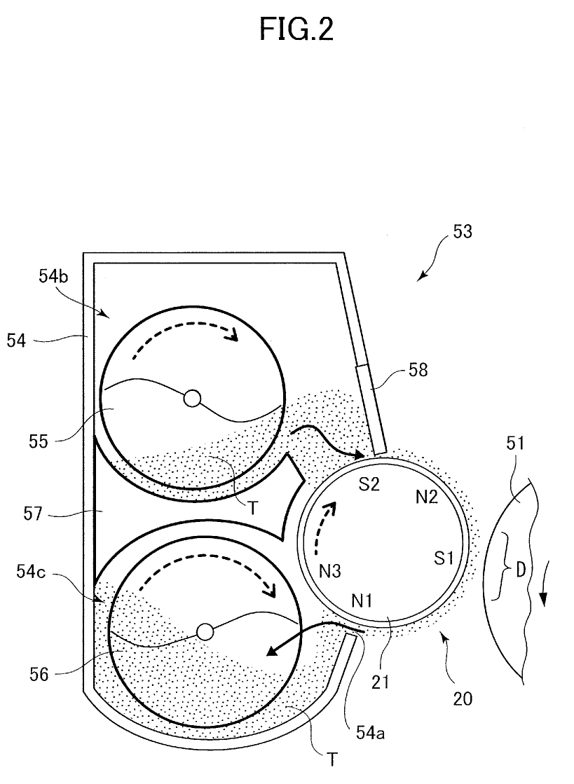

The image forming portion 40 includes image forming units 50y, 50m, 50c, and 50k, toner bottles 41y, 41m, 41c, and 41k, exposure units 42y, 42m, 42c, and 42k, an intermediate transfer unit 44, a secondary transfer portion 45, and a fixing portion 46. The image forming portion 40 is configured to be able to form an image on the sheet S based on image information. It is noted that the image forming apparatus 1 of the present embodiment is adaptable to full-color printing and is provided with the image forming units 50y, 50m, 50c, and 50k separately with the same configuration for four colors of yellow (y), magenta (m), cyan (c), and black (k), respectively. Due to that, while the respective components of the four colors are denoted with color identifiers after the same reference numerals in FIG. 1, the image forming unit will be denoted only by the reference numeral without appending the color identifiers in FIG. 2 and in the description.

In the present embodiment, two-component developer which is a mixture of non-magnetic toner and magnetic carrier is used as the developer. The toner includes abiding resin, a coloring agent, and according to a need, coloring resin particles containing other additives and coloring particles to which external additive such as colloidal silica fine powders is externally added. The toner is negatively charged polyester resin, and a number average diameter of the toner is 6.0 μm in the present embodiment. Metals such as surface oxidized or unoxidized iron, nickel, cobalt, manganese, chrome and rare earth and their alloys or ferrite oxide are applicable as the carrier. It is noted that a manufacturing method of these magnetic particles is not specifically limited. Still further, a number average diameter of the carrier is 35 μm in the present embodiment.

The image forming units include four image forming units 50y, 50m, 50c, and 50k to form four color toner images. Each image forming unit 50 includes a photosensitive drum (image bearing member) 51 on which a toner image is formed, an electrification roller 52, the developing apparatus 53, and a cleaning blade 59.

The electrification roller 52 is brought into contact with the surface of the photosensitive drum 51 to electrify the surface of the photosensitive drum 51. After the electrification, electrostatic latent images are formed on the surfaces of the respective photosensitive drums 51 by the exposure units 42y, 42m, 42c, and 42k based on image information. The photosensitive drum 51 circularly rotates while bearing the electrostatic latent image formed on the surface thereof, and the electrostatic latent image is developed by the developing apparatus 53 by the toner. A detailed configuration of the developing apparatus 53 will be described later.

The developed toner image is primarily transferred onto an intermediate transfer belt 44b described later. The cleaning blade 59 is disposed in contact with the surface of the photosensitive drum 51 and cleans the developer left on the surface of the photosensitive drum 51 after the primary transfer. The surface of the photosensitive drum 51 is destaticized by a pre-exposure unit not illustrated after the primary transfer. After that, residual substance such as the transfer residual toner left on the surface of the photosensitive drum 51 is removed from the surface of the photosensitive drum 51 by the cleaning blade 59.

The intermediate transfer unit 44 is disposed under the image forming units 50y, 50m, 50c, and 50k. The intermediate transfer unit 44 includes a plurality of rollers such as a driving roller 44a, a driven roller not illustrated, primary transfer rollers 44y, 44m, 44c, and 44k, and an intermediate transfer belt 44b wrapped around these rollers. The primary transfer rollers 44y, 44m, 44c, and 44k are disposed so as to face the photosensitive drums 51y, 51m, 51c, and 51k, respectively, and so as to be in contact with the intermediate transfer belt 44b.

The respective negative toner images on the photosensitive drums 51y, 51m, 51c, and 51k are sequentially superimposed and transferred onto the intermediate transfer belt 44b by a positive transfer bias applied to the intermediate transfer belt 44b through the primary transfer rollers 44y, 44m, 44c, and 44k. Thereby, the intermediate transfer belt 44b moves the toner images obtained by developing and transferring the electrostatic latent images on the surface of the photosensitive drums 51y, 51m, 51c, and 51k.

The secondary transfer portion 45 includes a secondary transfer inner roller 45a and a secondary transfer outer roller 45b. The full-color toner image formed on the intermediate transfer belt 44b is transferred onto the sheet S by a positive secondary transfer bias applied to the secondary transfer outer roller 45b. The fixing portion 46 includes a fixing roller 46a and a pressure roller 46b. The toner image that has been transferred onto the sheet S is heated and pressurized by being nipped and conveyed between the fixing roller 46a and the pressure roller 46b and is fixed to the sheet S.

The sheet discharge portion 60 includes a discharge roller pair 61 disposed downstream of a discharge path, a discharge port 62 disposed on a side of the apparatus body 10, and a discharge tray 63. The discharge roller pair 61 is capable of feeding the sheet S conveyed from the discharge path and of discharging out of the discharge port 62. The sheet S discharged out of the discharge port 62 is stacked on the discharge tray 63.

A control portion 70 is composed of a computer and includes a CPU, a ROM storing programs controlling each portion, a RAM temporarily storing data, and an input/output circuit inputting/outputting signals from inside/to outside. The CPU is a microprocessor managing the whole control of the image forming apparatus 1 and is a main body of a system controller. The CPU is connected with the sheet feed portion 30, the image forming portion 40, the sheet conveyance portion, the sheet discharge portion 60, and the operation portion through the input/output circuit to exchange signals with and to control operations of the respective portions.

Next, an image forming operation of the image forming apparatus 1 constructed as described above will be described.

When the image forming operation starts, the photosensitive drum 51 is rotated at first such that the surface thereof is electrified by the electrification roller 52. Then, the exposure unit 42 emits a laser light to the photosensitive drum 51 based on image information to form an electrostatic latent image on the surface of the photosensitive drum 51. Toner is caused to adhere to the electrostatic latent image to develop and visualize as a toner image which is to be transferred onto the intermediate transfer belt 44b.

Meanwhile, in parallel with the toner image forming operation, the feed roller 32 rotates and feeds, while separating, an uppermost sheet S in the sheet cassette 31. Then, while synchronizing with the toner image on the intermediate transfer belt 44b, the sheet S is conveyed to the secondary transfer portion 45 through the conveyance path. Then, the toner image is transferred onto the sheet S from the intermediate transfer belt 44b. The sheet S on which the toner image has been transferred is conveyed to the fixing portion 46 to be heated and pressurized to fix the non-fixed toner image on the surface of the sheet S. The sheet S is then discharged by the discharge roller pair 61 out of the discharge port 62 and is stacked on the discharge tray 63.

Next, the developing apparatus 53 will be described in detail with reference to FIG. 2. The developing apparatus 53 includes a developer container 54 storing the two-component developer, conveyance screws 55 and 56, and a developing sleeve (developer bearing member) 20. The developer container 54 has an opening part 54a from which the developing sleeve 20 is exposed at a position facing the photosensitive drum 51.

The toner is supplied to the developer container 54 from the toner bottle 41 in which the toner is filled. The developer container 54 includes a partition wall 57 extending at an approximately center part in a longitudinal direction of the developer container 54. The developer container 54 is partitioned up and down by the partition wall 57 into a developing chamber 54b and an agitating chamber 54c. The developer T is stored in these developing and agitating chambers 54b and 54c. The developing chamber 54b is configured to supply the developer T to the developing sleeve 20. The agitating chamber 54c communicates with the developing chamber 54b and collects the developer T from the developing sleeve 20.

The first conveyance screw 55 is disposed within the developing chamber 54b approximately in parallel with the developing sleeve 20 along an axial direction of the developing sleeve 20 and conveys, while agitating, the developer T within the developing chamber 54b. The second conveyance screw 56 is disposed within the agitating chamber 54c approximately in parallel with a shaft of the first conveyance screw 55 and conveys the developer T within the agitating chamber 54c in a direction opposite to a direction in which the first conveyance screw 55 conveys the developer T. The toner is negatively tribo-electrified by being rubbed with the carrier.

A regulating blade 58 is provided above the opening part 54a of the developer container 54. The regulating blade 58 is fixed such that a predetermined gap is defined between a front edge of the regulating blade 58 and the developing sleeve 20 to regulate a thickness of a layer of the developer T borne on the surface of the developing sleeve 20.

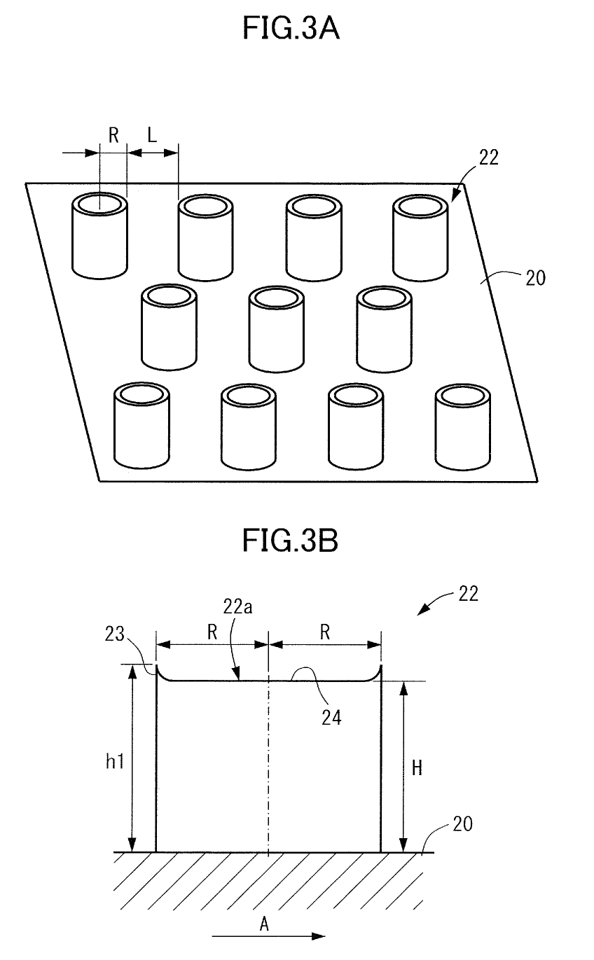

The developing sleeve 20 is formed of a non-magnetic material such as aluminum and non-magnetic stainless. The developing sleeve 20 is formed of aluminum in the present embodiment. A magnetic substance portion 22 (see FIG. 3) is provided on the surface of the developing sleeve 20. That is, the developing sleeve 20 includes, on the surface thereof, a plurality of magnetic substance portions 22 bearing, on an end surface thereof, and conveying the developer T to the developing area D facing the photosensitive drum 51. The magnetic substance portion 22 will be detailed later.

The developing sleeve 20 is connected with a high-voltage power supply not illustrated that applies a development bias in which DC and AC voltages are superimposed. The developing sleeve 20 rotates in a direction indicated by an arrow in FIG. 2 and bears and carries the developer T to the developing area D on the surface of the photosensitive drum 51 after regulating the thickness of the developer T borne on the surface of the developing sleeve 20 by the regulating blade 58 to an adequate thickness. The developing sleeve 20 executes the development process by causing the toner to adhere the electrostatic latent image by the development bias.

A roller-like magnet roller (magnetic flux generating member) 21 is fixedly set unrotationally with respect to the developer container 54 within the developing sleeve 20. The magnet roller 21 includes a developing magnetic pole S1 facing the developing area D. Besides the developing magnetic pole S1, the magnet roller 21 includes magnetic poles S2, N1, N2 and N3. The magnet roller 21 generates magnetic fluxes capable of passing through the magnetic substance portion 22 as described later.

A magnetic brush of the developer T is formed approximately at a position facing the photosensitive drum 51 by a development magnetic field formed by the developing magnetic pole S1 in the developing area D and develops the electrostatic latent image on the photosensitive drum 51 rotating in the direction of the arrow in the developing area D. The developer T that has passed through the developing area D is conveyed on the developing sleeve 20 by the magnetic poles such as the magnetic pole N1 of the magnet roller 21 disposed such that adjacent magnetic poles are heteropolar and is peeled from the developing sleeve 20 by a repulsive magnetic field formed by the magnetic poles N1 and N3. The peeled developer T is agitated and conveyed in the agitating chamber 54c and is supplied to the developing sleeve 20 again from the developing chamber 54b.

Next, the magnetic substance portion 22 provided on the surface of the developing sleeve 20 will be described in detail with reference to FIGS. 3A and 3B. As illustrated in FIG. 3A, a large number of columnar magnetic substance portions 22 is formed regularly on the surface of the developing sleeve 20. The magnetic substance portions 22 are regularly formed in a staggered arrangement in which the magnetic substance portions 22 are disposed at equal intervals by every 60 degrees around each other. Here, if the arrangement of the magnetic substance portions 22 is irregular, an arrangement of the magnetic brushes in the developing area D becomes irregular, possibly causing unevenness of a conveyance amount of the developer and density unevenness in an output image due to the sparse and dense arrangements of the magnetic substance portions 22. It is possible to suppress such density unevenness of an output image by the present embodiment because the arrangement of the magnetic substance portions 22 is regular. It is also possible to make the magnetic fluxes concentrate efficiently on each magnetic substance portion 22 by regularly arranging the magnetic substance portions 22.

Because the magnetic substance portion 22 is columnar, it is easy to manufacture. It is also preferable because the magnetic substance portions 22 are isotropic in a plane direction of the developing sleeve 20. However, the shape of the magnetic substance portion 22 is not limited to be columnar and may assume any shape such as a quadrangular columnar shape, a truncated cone shape, and a pyramid shape. Still further, the magnetic substance portion 22 is preferably formed of a material such as Ni having higher magnetic permeability than the carrier, and a Ni—P alloy of magnetic permeability of 10 is used in the present embodiment.

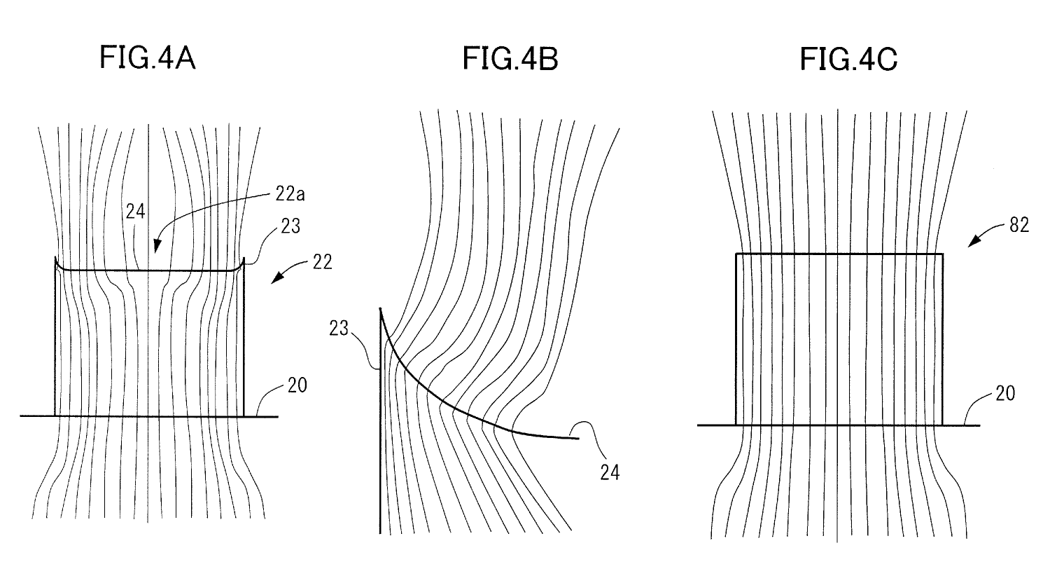

As illustrated in FIG. 3B, the magnetic substance portion 22 has a high flux density portion (first portion) 23 and a low flux density portion (second portion) 24 on an end surface 22a thereof. The high flux density portion 23 is disposed at an outer edge of the end surface 22a and projects out of an outer edge of the end surface 22a. High density fluxes pass more through the high flux density portion 23 than the low flux density portion 24 (see FIG. 4A). It is noted that while the high flux density portion 23 is formed annularly along the entire peripheral portion of the end surface 22a, the shape of the high flux density portion 23 is not limited to that. That is, the high flux density portion 23 may be disposed at least either one of upstream in a conveyance direction A of the developing sleeve 20 (upstream in the conveyance direction) or downstream (downstream in the conveyance direction). The low flux density portion 24 is disposed at a center part of the end surface 22a, and low density fluxes pass more through the low flux density portion 24 than the high flux density portion 23 (see FIG. 4A). Therefore, the end surface 22a is concaved as a whole. It is noted that a height h1 from a front end of the high flux density portion 23 to the surface of the developing sleeve 20 is higher than a height H from the low flux density portion 24 to the surface of the developing sleeve 20.

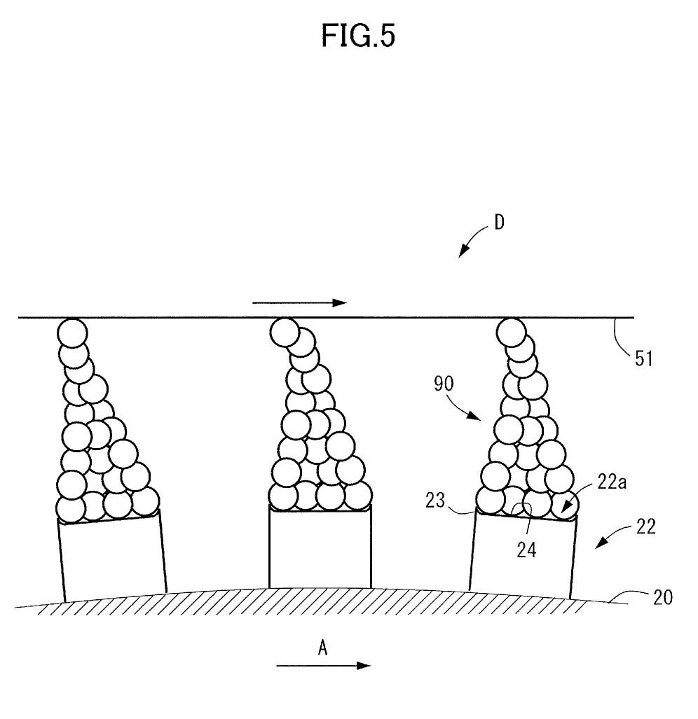

Next, a state in which the developer T is conveyed in the developing area D by the developing sleeve 20 will be described in detail. The developer T forms the magnetic brush by the magnetic field formed by the developing magnetic pole S1 of the magnet roller 21 in the developing area D. If strength of the magnetic field is represented by magnetic fluxes, the magnetic fluxes formed by the developing magnetic pole S1 concentrate to the magnetic substance portion 22 where magnetic permeability is high on the surface of the developing sleeve 20 as illustrated in FIG. 4A because the magnetic fluxes preferentially pass through a material having high magnetic permeability. The magnetic fluxes that have passed through the inside of the magnetic substance portion 22 concentrate to the high flux density portion 23 of the magnetic substance portion 22 this time by the concave shape in the end surface 22a of the magnetic substance portion 22. Still further, because the magnetic fluxes generated from the magnetic substance portion 22 are refracted in a direction vertical to the surface of the magnetic substance portion 22 at a boundary surface between the magnetic substance portion 22 and air, the magnetic fluxes orient in a direction of the center of the magnetic substance portion 22 as illustrated in FIG. 4B at a boundary surface formed at the high flux density portion 23. Due to that, the density of the magnetic fluxes increases further after going out of the high flux density portion 23. When a magnetic brush is formed on the surface of the developing sleeve 20, the developer T is at first restrained by the high flux density portion 23 where the magnetic fluxes are concentrated most. Then, the developer T is restrained by the low flux density portion 24 surrounded by the high flux density portion 23. As a result, a magnetic brush 90 is formed on the end surface 22a of the magnetic substance portion 22 by the magnetic fluxes formed by the developing magnetic pole S1 as illustrated in FIG. 5.

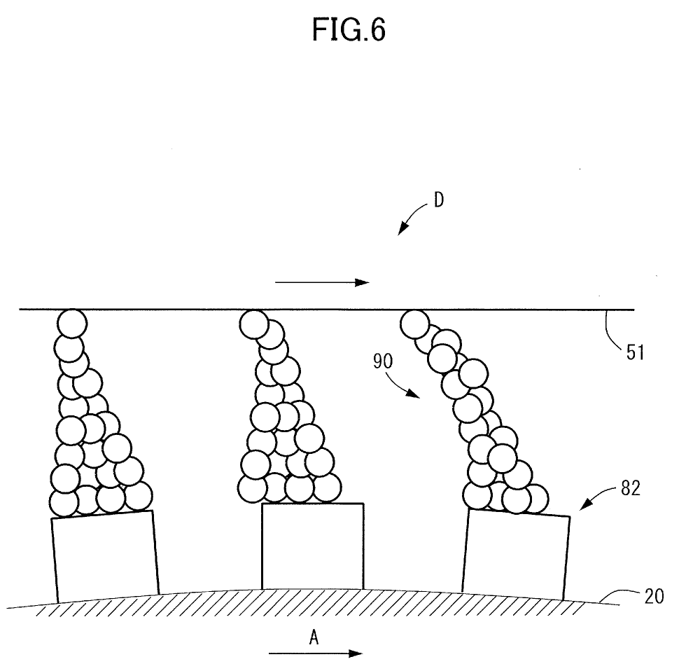

In the developing area D, the magnetic brush 90 rubs the photosensitive drum 51 after coming into contact with the photosensitive drum 51 with a difference of peripheral speeds of the developing sleeve 20 and the photosensitive drum 51. Here, if the end surface of the magnetic substance portion 82 is not concaved as illustrated in FIG. 4C, magnetic flux density becomes approximately uniform at the end surface of the magnetic substance portion 82. Due to that, a force restraining the developer T of the upper end surface of the magnetic substance portion 82 is weak as compared to the case in which the end surface is concaved. As a result, it is unable to fully restrain the magnetic brush 90 by the outer edge, and there is a case when a conveyance failure occurs because the magnetic brush 90 slips out of the end surface of the magnetic substance portion 82 when the magnetic brush 90 comes into contact with and rubs the photosensitive drum 51 as illustrated in FIG. 6.

However, the end surface 22a of the magnetic substance portion 22 is concaved in the present embodiment. Due to that, the developer T of the magnetic brush 90 strongly restrained by the high flux density portion 23 is suppressed from slipping out of the end surface 22a of the magnetic substance portion 22 when the magnetic brush 90 comes into contact with and rubs the photosensitive drum 51 as illustrated in FIG. 5. The carriers composing the magnetic brush 90 are strongly restrained by the high flux density portion 23 upstream in the conveyance direction A of the end surface 22a and exhibits resistance in an upstream pulling direction against an external force acting downstream on the magnetic brush 90. Still further, the carriers composing the magnetic brush 90 are strongly restrained by the high flux density portion 23 downstream in the conveyance direction A of the end surface 22a and suppresses the magnetic brush 90 from falling out of a downstream end of the end surface 22a by external force acting from upstream.

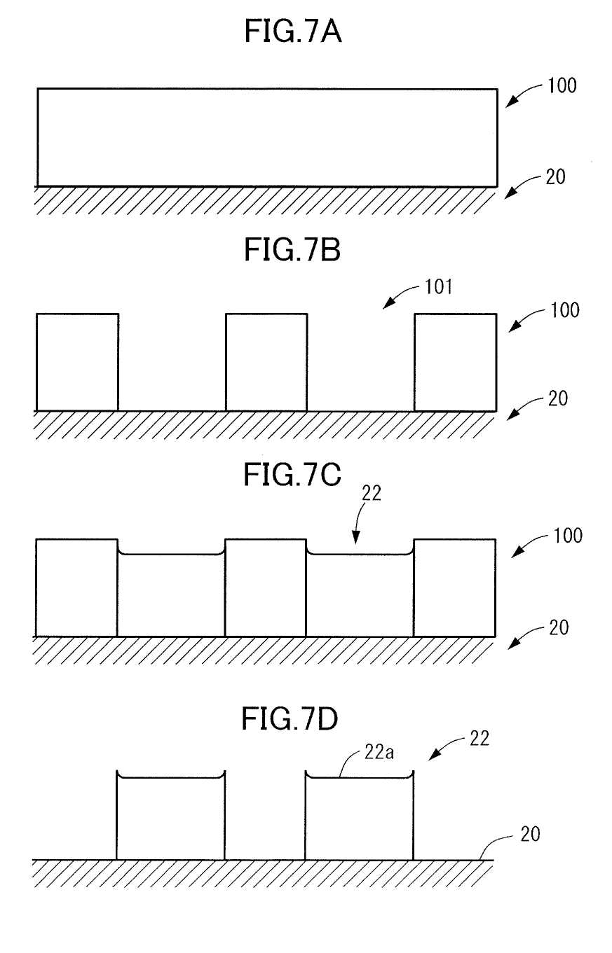

Next, a procedure for manufacturing the magnetic substance portion 22 on the surface of the developing sleeve 20 will be described with reference to FIGS. 7A through 7D. At first, as illustrated in FIG. 7A, a uniform resist film 100 is formed on the surface of the developing sleeve 20 formed of aluminum. Then, as illustrated in FIG. 7B, a resist pattern leaving the resists 100 at non-forming portions 101 where no magnetic substance portions 22 is to be formed later is formed (see FIG. 7C) by implementing masking exposure. After that, as illustrated in FIG. 7C, an electrolytic plating process is executed with Ni—P alloy so as to deposit the magnetic substance portion 22 in the non-forming portion 101 (see FIG. 7B). At this time, current density is higher at the peripheral portion in the magnetic substance portion 22 to be deposited, so that the peripheral portion grows higher as compared to the center part. Then, it is possible to form the magnetic substance portions 22 in which the outer edge of the end surface 22a projects upward on the developing sleeve 20 by removing the resist 100 as illustrated in FIG. 7D.

As described above, according to the developing apparatus 53 of the present embodiment, the end surface 22a of the magnetic substance portion 22 is provided with the high flux density portion 23 disposed at least either one of the upstream and downstream parts in the conveyance direction A of the developing sleeve 20 and the low flux density portion 24. Therefore, magnetic flux density becomes high at the high flux density portion 23 more than that of the low flux density portion 24, so that the force strongly restraining the magnetic brush 90 acts at least one of the upstream and downstream parts in the conveyance direction A of the end surface 22a of the magnetic substance portion 22. Due to that, the carriers strongly restrained by the high flux density portion 23 suppress the magnetic brush 90 from slipping out of the end surface 22a of the magnetic substance portion 22, and it is possible to reduce the conveyance failure of the developer T even if a force in the conveyance direction acts on the magnetic brush 90. That is, it is possible to suppress the conveyance failure of the magnetic brush 90 from occurring otherwise caused by the rotation of the developing sleeve 20.

Still further, according to the developing apparatus 53 of the present embodiment, it is possible to form the magnetic substance portions 22 on the surface of the developing sleeve 20 by disposing the resist pattern, by implementing electrolytic plating, and by removing the resist pattern. Therefore, it is possible to dispose the magnetic substance portions 22 on the developing sleeve 20 with less man-hour and to cut an increase of costs.

### First Example

The inventors measured densities of output images by using the developing apparatus 53 including the magnetic substance portion 22 of the present embodiment described above. The inventors used density measured values measured by X-Rite530 manufactured by X-Rite Co. in a STATUS-A mode as indices of evaluation of the image density. Here, each parameter was set as follows. The magnetic permeability of the magnetic substance portion 22: 10, the radius R of the magnetic substance portion 22: 50 μm, the height H of the magnetic substance portion 22: 100 μm, the height h1 of the high flux density portion 23: 105 μm, the distance L between magnetic substance portions 22: 20 μm, and the regular arrangement of the magnetic substance portions 22: staggered arrangement with an angle of 60°. Table 1 indicates measured results thereof.

### First Comparative Example

The inventors measured densities of output images by using the developing apparatus including the magnetic substance portion 82 illustrated in FIGS. 4C and 6. Here, the magnetic substance portion 82 whose end surface is flat was obtained by polishing the end face of the magnetic substance portion 22 after forming the magnetic substance portion 22 on the surface of the developing sleeve 20 by using the same method with the first embodiment. That is, the magnetic substance portion 82 has no high and low flux density portions on the end surface thereof. Here, each parameter was set as follows. The magnetic permeability of the magnetic substance portion 82: 10, the radius R of the magnetic substance portion 82: 50 μm, the height H of the magnetic substance portion 82: 100 μm, the distance L between magnetic substance portions 82: 20 μm, and the regular arrangement of the magnetic substance portions 82: staggered arrangement with an angle of 60°. Table 1 indicates measured results thereof.

TABLE 1

| | FIRST COMPARATIVE | |
|---|---|---|
| | EXAMPLE | FIRST EXAMPLE |
| TONER | 0.9 | 1.2 |
| CONCENTRATION | | |

As indicated in Table 1, the toner concentration of the first example was higher than that of the first comparative example. As illustrated in FIG. 5, it was confirmed by the first example that the developer T of the high flux density portion 23 strongly restrained suppresses the magnetic brush 90 from slipping out of the end surface 22a of the magnetic substance portion 22 when the magnetic brush 90 comes into contact with and rubs the photosensitive drum 51 and that the toner concentration improves.

### Second Example

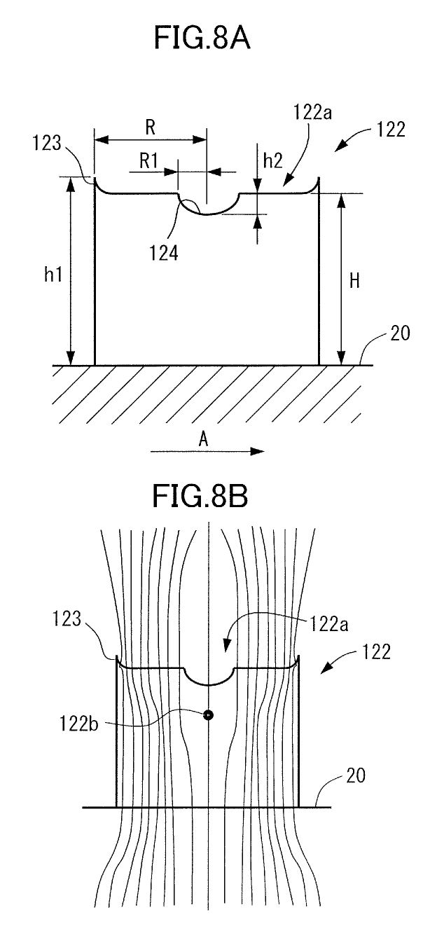

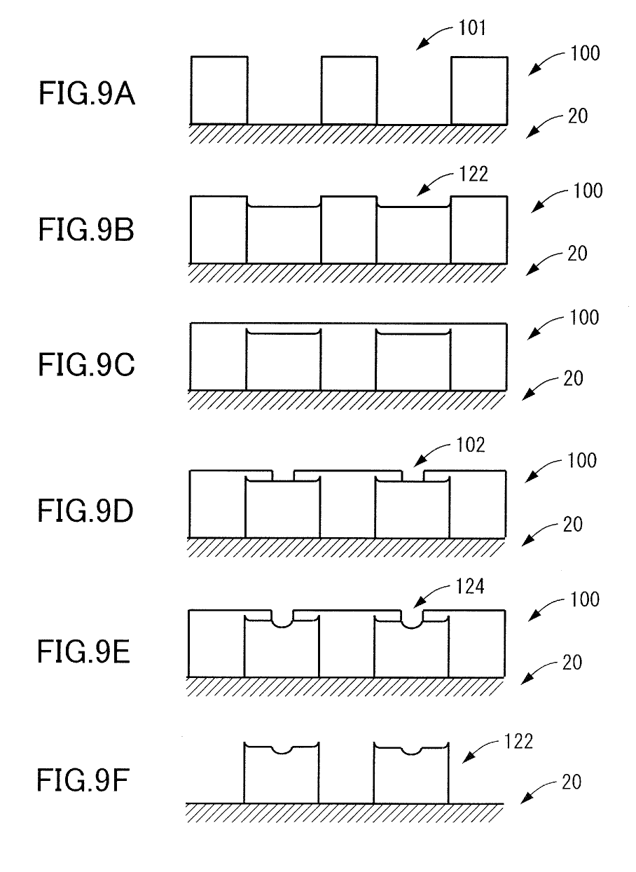

Next, a developing apparatus 53 of a second embodiment will be described with reference to FIGS. 8A through 9F. The developing apparatus 53 of the present embodiment is constructed in the same manner with the first embodiment except that a shape of a magnetic substance portion 122 is different, so that components of the developing apparatus 53 will be denoted by the same reference numerals and a detailed description thereof will be omitted here.

As illustrated in FIG. 8A, the magnetic substance portion 122 includes, on its end surface 122a, a high flux density portion 123, and a low flux density portion 124 concaved from the end surface 122a in the present embodiment. That is, the low flux density portion 124 serving as a second portion is concaved so as to be lower than the high flux density portion 123 serving as a first position on the end surface 122a. The low flux density portion 124 is full-orbed in plan view. In this case, flux lines from the developing sleeve 20 pass through so as to keep away from the low flux density portion 124 as illustrated in FIG. 8B, magnetic flux density of the high flux density portion 123 can be increased further.

Here, as a route where the magnetic flux passing through a point 122b of the magnetic substance portion 122 reaches the end surface 122a of the magnetic substance portion 122, there is a route of passing through the low flux density portion 124 and air and a route of passing through an inside of the magnetic substance portion 122 by keeping away from the low flux density portion 124. It is possible to find which path the magnetic flux passes through by comparing magnetic distances obtained by dividing distances through which the magnetic fluxes pass by magnetic permeability. Where a maximum depth of the low flux density portion 124 is set as h2, a radius of an opening of the low flux density portion 124 as R1, and relative permeability of the magnetic substance portion 122 as u 1, the magnetic distance of the route passing through the low flux density portion 124 of the former case is h2 and the magnetic distance of the route keeping away the low flux density portion 124 of the latter case is (R1+h2)/μ1. Therefore, if a relationship of (R1+h2)/h2<μ1 is met, the magnetic flux passes through the inside of the magnetic substance portion 122. Then, the magnetic fluxes are concentrated more, permitting to restrain the developer T more strongly by the high flux density portion 123.

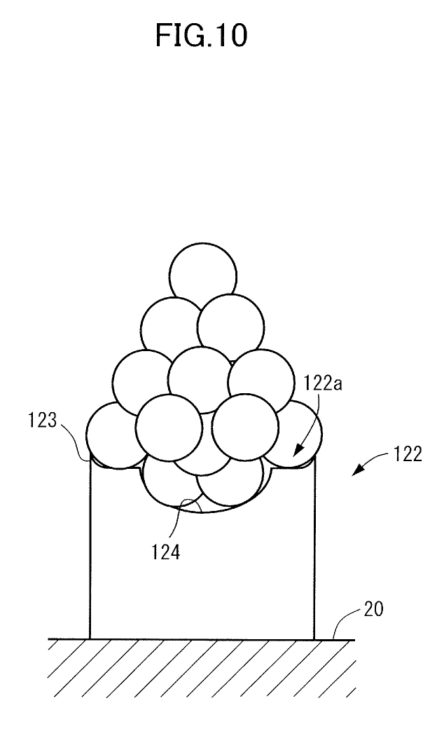

Still further, because the flux lines passing through the magnetic substance portion 122 try to shorten the magnetic distance to be passed as less as possible, the flux lines pass preferentially through the inside of the magnetic substance portion 122 than the air. Therefore, the fluxes are concentrated at the part, other than the concaved low flux density portion 124, of the magnetic substance portion 122. A number of fluxes passing through the magnetic substance portion 122 are approximately equal to a number of fluxes entering from the surface of the developing sleeve 20 to the magnetic substance portion 122. For instance, in a magnetic substance portion 122 illustrated in FIG. 10 including a low flux density portion 124 which is larger than the low flux density portion 124 illustrated in FIG. 8B, a rate of an area of the low flux density portion 124 to an area of the end surface 122a of the magnetic substance portion 122 becomes large. In this case, magnetic flux density passing through the end surface 122a sharply increases because a rate of an opening area of the low flux density portion 124 to the area of the end surface 122a of the magnetic substance portion 122 increases. Since the magnetic restraint force acting on the developer T is proportional to spatial gradient of square of magnetic flux density, the force restraining the developer T by the low flux density portion 124 increases more sharply if the rate of the area of the low flux density portion 124 to the area of the end surface 122a of the magnetic substance portion 122 increases. According to the present embodiment, the rate of the opening area of the low flux density portion 124 of the magnetic substance portion 122 is preferable to be 30% or more of the area of the end surface 122a of the magnetic substance portion 122. This arrangement makes it possible to restrain the magnetic brush strongly to the magnetic substance portion 122 and to obtain favorable image density.

Next, a procedure for manufacturing the magnetic substance portion 122 on the surface of the developing sleeve 20 will be described with reference to FIGS. 9A through 9F. At first, a uniform resist film 100 is formed on the surface of the developing sleeve 20 formed of aluminum. Then, as illustrated in FIG. 9A, a resist pattern leaving resists 100 at non-forming portions 101 of the magnetic substance portion 122 is formed as illustrated in FIG. 9A by implementing masking exposure. After that, as illustrated in FIG. 9B, an electrolytic plating process is executed on the developing sleeve 20 with Ni—P alloy so as to deposit the magnetic substance portion 122 in the non-forming portion 101. At this time, current density is higher at the peripheral portion in the magnetic substance portion 22 to be deposited, so that the peripheral portion grows higher as compared to the center part.

Still further, after removing the pattern of the resist 100 once, a uniform resist film 100 is formed again on the surface 20 as illustrated in FIG. 9C. Then, a pattern of the resist 100 in which a non-forming portion 102 where only a center portion of the magnetic substance portion 122 is exposed is disposed by implementing masking exposure only on the center portion of the magnetic substance portion 122 as illustrated in FIG. 9D. Next, the center portion of the magnetic substance portion 122 is etched by an etching solution as illustrated in FIG. 9E. Finally, it is possible to form the magnetic substance portions 22 in which the outer edge of the end surface 122a projects upward on the developing sleeve 20 by removing the resist 100 as illustrated in FIG. 9F.

As described above, according to the developing apparatus 53 of the present embodiment, the end surface 22a of the magnetic substance portion 22 is provided with the high flux density portion 23 projecting upward and the concaved low flux density portion 24. Due to that, it is possible to increase a difference of elevation of the high and low flux density portions 23 and 24. This arrangement makes it possible to concentrate the fluxes to the high flux density portion 23 and to more strongly restrain the developer T by the high flux density portion 23.

### Second Through Tenth Examples

The inventors measured densities of output images by using the developing apparatus 53 including the magnetic substance portion 122 of the abovementioned embodiment. The image densities were evaluated in the same manner with the first embodiment. Here, each parameter was set as follows. The magnetic permeability of the magnetic substance portion 122: 10, the radius R of the magnetic substance portion 122: 50 μm, the height H of the magnetic substance portion 122: 100 μm, a height h1 of the high flux density portion 123: 105 μm, the distance L between the magnetic substance portions 122: 20 μm, and the regular arrangement of the magnetic substance portions 122: staggered arrangement with an angle of 60°. Still further, a radius R1 of the low flux density portion 124 of the magnetic substance portion 122 and a depth h2 of the low flux density portion 124 were differentiated in the second through tenth examples. Table 2 indicates measured results thereof.

TABLE 2

| | 2^{nd} | 3^{rd} | 4^{th} | 5^{th} | 6^{th} | 7^{th} | 8^{th} | 9^{th} | 10^{th} |
|---|---|---|---|---|---|---|---|---|---|
| | EXAMPLE | EXAMPLE | EXAMPLE | EXAMPLE | EXAMPLE | EXAMPLE | EXAMPLE | EXAMPLE | EXAMPLE |
| R1 (μm) | 0 | 10 | 10 | 10 | 10 | 20 | 20 | 20 | 20 |
| h2 (μm) | 0 | 1 | 2 | 3 | 5 | 1 | 2 | 3 | 5 |
| (R1 + h2)/ | — | X | ◯ | ◯ | ◯ | X | X | ◯ | ◯ |
| h2 < μ1 | | | | | | | | | |
| TONER | 1.2 | 1.2 | 1.3 | 1.3 | 1.3 | 1.2 | 1.2 | 1.3 | 1.3 |
| CONCEN- | | | | | | | | | |
| TRATION | | | | | | | | | |

Accordingly, as Table 2 indicates, it is possible to obtain the more favorable image densities in the fourth through sixth, ninth, and tenth examples in which the relationship of (R1+h2)/h2<μ1 is met as compared to the other examples. Thus, it was confirmed that when the relationship of (R1+h2)/h2<μ1 is met, the fluxes pass through the inside of the magnetic substance portion 122, the fluxes are more concentrated, and that the developer T is strongly restrained by the high flux density portion 123. 11^{th} through 14^{th} Examples

The inventors measured densities of output images by using the developing apparatus 53 including the magnetic substance portion 122 of the abovementioned embodiments. The image densities were evaluated in the same manner with the first embodiment. Here, each parameter was set as follows. The magnetic permeability of the magnetic substance portion 122: 10, the radius R of the magnetic substance portion 122: 50 μm, the height H of the magnetic substance portion 122: 100 μm, a height h1 of the high flux density portion 123: 105 μm, the distance L between the magnetic substance portions 122: 20 μm, and the regular arrangement of the magnetic substance portions 122: staggered arrangement with an angle of 60°. Still further, a depth h2 of the low flux density portion 124 was set as 5 μm, and a radius R1 of the low flux density portion 124 and an opening area Sa of the magnetic substance portion 122 were differentiated. Table 3 indicates measured results thereof (where, S is an area of the end surface 122a).

TABLE 3

| | 11^{th} | 12^{th} | 13^{th} | 14^{th} |
|---|---|---|---|---|
| | EXAMPLE | EXAMPLE | EXAMPLE | EXAMPLE |
| R1 (μm) | 10 | 20 | 30 | 40 |
| Sa/S (%) | 4 | 16 | 36 | 64 |
| TONER | 1.3 | 1.3 | 1.4 | 1.4 |
| CONCEN- | | | | |
| TRATION | | | | |

Accordingly, as Table 3 indicates, the more favorable image densities can be obtained in the 13^{-th} and 14^{-th} examples in which the area Sa of the low flux density portion 124 is 30% or more (0.3×S) of the area S of the end surface 122a of the magnetic substance portion 122 as compared to the other examples. Thus, it was confirmed that the fluxes are more concentrated and the developer T can be more strongly restrained by the high flux density portion 123 when the area Sa of the low flux density portion 124 is 30% or more of the area S of the end surface 122a of the magnetic substance portion 122.

### Third Embodiment

Next, a developing apparatus 53 of a third embodiment will be described with reference to FIG. 10. The developing apparatus 53 of the present embodiment is constructed in the same manner with the second embodiment except that a shape of a low flux density portion 124 is different, so that components of the developing apparatus 53 will be denoted by the same reference numerals with the second embodiment and a detailed description thereof will be omitted here.

According to the present embodiment, the carriers can enter a hollow part of the low flux density portion 124 as illustrated in FIG. 10. That is, a diameter 2R1 of the low flux density portion 124 of the magnetic substance portion 22 is larger than the number average diameter 2r of the carrier and a depth h2 of the low flux density portion 124 is larger than a number average radius r of the carrier. The developer can enter the hollow part of the low flux density portion 124 enlarging the diameter 2R1 of the low flux density portion 124 of the magnetic substance portion 22 more than the number average diameter 2r of the carrier. It is also possible to generate a force mechanically restraining the developer by a wall surface of the low flux density portion 124 in addition to the magnetic restraining force by deepening the depth h2 of the low flux density portion 124 more than the number average diameter r. This arrangement makes it possible to hold the magnetic brush in the magnetic substance portion 122 more strongly.

Here, although a demagnetizing field that weakens the magnetic force acts on the adjacent magnetic substance portions 122 among each other, this effect attenuates with square of a distance when the distance between the magnetic substance portions 122 expands. The restraining force of the magnetic substance portion 122 acting on the magnetic brush is weakened by the demagnetizing field. However, because the restraining force attenuates with a spatial gradient of square of strength of magnetic field, the effect of the demagnetizing field receiving from an adjacent magnetic substance portion 122 attenuates sharply when the distance L between the magnetic substance portions 122 increases (see FIG. 3A). According to the present embodiment, the distance L between the magnetic substance portions 122 is preferable to be 50% (0.5R) or more of the radius R of the magnetic substance portion 122. This arrangement makes it possible to retain the magnetic brush to the magnetic substance portion 122 and to obtain the favorable image density.

### 15^{-th} Through 23^{rd} Examples

The inventors measured densities of output images by using the developing apparatus 53 including the magnetic substance portion 122 of the abovementioned embodiments. The image densities were evaluated in the same manner with the first embodiment. Here, each parameter was set as follows. The magnetic permeability of the magnetic substance portion 122: 10, the radius R of the magnetic substance portion 122: 50 μm, the height H of the magnetic substance portion 122: 100 μm, a height h1 of the high flux density portion 123: 105 μm, the distance L between the magnetic substance portions 122: 20 μm, and the regular arrangement of the magnetic substance portions 122: staggered arrangement with an angle of 60°. A number average diameter 2r: magnetic particles of 35 μm were used in the same manner with the first embodiment. Still further, a radius R1 of the low flux density portion 124 and a depth h2 of the low flux density portion 124 of the magnetic substance portion 122 were differentiated in the 15^{-th} through 23^{-rd} examples. Table 4 indicates measured results thereof.

TABLE 4

| | 15^{th} | 16^{th} | 17^{th} | 18^{th} | 19^{th} | 20^{th} | 21^{st} | 22^{nd} | 23^{rd} |
|---|---|---|---|---|---|---|---|---|---|
| | EXAMPLE | EXAMPLE | EXAMPLE | EXAMPLE | EXAMPLE | EXAMPLE | EXAMPLE | EXAMPLE | EXAMPLE |
| R1 (μm) | 10 | 10 | 10 | 20 | 20 | 20 | 30 | 30 | 30 |
| h2 (μm) | 10 | 20 | 30 | 10 | 20 | 30 | 10 | 20 | 30 |
| 2R1 > 2r | X | X | X | ◯ | ◯ | ◯ | ◯ | ◯ | ◯ |
| h2 > r | X | ◯ | ◯ | X | ◯ | ◯ | X | ◯ | ◯ |
| TONER | 1.4 | 1.4 | 1.4 | 1.4 | 1.5 | 1.5 | 1.4 | 1.5 | 1.5 |
| CONCEN- | | | | | | | | | |
| TRATION | | | | | | | | | |

Accordingly, as Table 4 indicates, the diameter 2R1 of the low flux density portion 124 is larger than the number average diameter 2r of the carrier and the depth h2 of the low flux density portion 124 is larger than the number average diameter r of the carrier in the 19^{th}, 20^{th}, 22^{nd}, and 23^{rd} examples. More favorable image densities could be obtained in these 19^{th}, 20^{th}, 22^{nd}, and 23^{rd} examples as compared to the other examples. Thus, it was confirmed that it is possible to generate the force mechanically restraining the developer by the wall surface of the low flux density portion 124, in addition to the magnetic restraining force, and to restrain the magnetic brush more strongly to the magnetic substance portion 122.

### 24^{th} Through 28^{th} Examples

The inventors measured densities of output images by using the developing apparatus 53 including the magnetic substance portion 122 of the abovementioned embodiments. The image densities were evaluated in the same manner with the first embodiment. Here, each parameter was set as follows. The magnetic permeability of the magnetic substance portion 122: 10, the radius R of the magnetic substance portion 122: 50 μm, the height H of the magnetic substance portion 122: 100 μm, a height h1 of the high flux density portion 123: 105 μm, and the regular arrangement of the magnetic substance portions 122: staggered arrangement with an angle of 60°. Still further, a radius R1 of the low flux density portion 124 was set as 30 μm, and a depth h2 of the low flux density portion 124 was set as 30 μm. Still further, the distance L between the magnetic substance portions 122 was differentiated in the 24^{-th} through 28^{-th} examples. Table 5 indicates measured results thereof.

TABLE 5

| | 24^{th} | 25^{th} | 26^{th} | 27^{th} | 28^{th} |
|---|---|---|---|---|---|
| | EXAM- | EXAM- | EXAM- | EXAM- | EXAM- |
| | PLE | PLE | PLE | PLE | PLE |
| L (μm) | 10 | 20 | 30 | 50 | 100 |
| L > 0.5R | X | X | ◯ | ◯ | ◯ |
| TONER | 1.5 | 1.5 | 1.6 | 1.6 | 1.6 |
| CONCEN- | | | | | |
| TRATION | | | | | |

Accordingly, as Table 5 indicates, it was possible to obtain more favorable image densities in the 26^{th}, 27^{th} and 28^{th} examples in which the distance L between the magnetic substance portions 122 is 50% or more of the radius R of the magnetic substance portion 122 as compared to the other examples. Thus, it was confirmed that it is possible to restrain the magnetic brush to the magnetic substance portion 122 more strongly by attenuating the effect of the demagnetizing field receiving from the adjacent magnetic substance portion 122.

While the cases in which the high flux density portions 23 and 123 are formed annularly along the entire outer edge of the end surfaces 22a and 122a of the magnetic substance portions 22 and 122 in the first through third embodiments described above, the present disclosure is not limited to such configuration. For instance, the high flux density portions 23 and 123 may be provided at both ends in the conveyance direction of the end faces 22a and 122a of the magnetic substance portions 22 and 122 or only at upstream or downstream in the conveyance direction of the end surfaces 22a and 122a.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2015-227262, filed Nov. 20, 2015, which is hereby incorporated by reference herein in its entirety.

What is claimed is:

1. A developing apparatus comprising:
a developer bearing member comprising a plurality of magnetic substance portions configured to bear developer containing toner and carrier on an end surface thereof and to convey the developer to a developing area facing an image bearing member; and
a magnetic flux generating member disposed within the developer bearing member and generating magnetic fluxes passing through the magnetic substance portion,
wherein each magnetic substance portion comprises, on the end surface, a first portion disposed at least one of upstream and downstream parts in a conveyance direction of the developer bearing member and through which the magnetic fluxes pass and a second portion through which the magnetic fluxes whose density is lower than the magnetic fluxes passing through the first portion pass.

2. The developing apparatus according to claim 1, wherein the first portion is disposed at an outer edge of the end surface.

3. The developing apparatus according to claim 1, wherein the second portion is disposed at a center part of the end surface.

4. A developing apparatus comprising:
a developer bearing member comprising a plurality of magnetic substance portions configured to bear developer containing toner and carrier on an end surface thereof and to convey the developer to a developing area facing an image bearing member;
a magnetic flux generating member disposed within the developer bearing member and configured to generate magnetic fluxes passing through each magnetic substance portion; and
a first portion provided on the magnetic substance portion and projecting from the outer edge of the end surface.

5. The developing apparatus according to claim 1, further comprising a second portion provided on the magnetic substance portion and concaved so as to be lower than the first portion on the end surface.

6. The developing apparatus according to claim 3, wherein the second portion is full-orbed in plan view, concaved from the end surface, and meets a relationship of (R1+h2)/h2<μ1,
where h2 is a depth of the second portion from the end surface, R1 is a radius of the second portion, and μ1 is a relative permeability of the magnetic substance portion.

7. The developing apparatus according to claim 5, wherein the second portion is full-orbed in plan view, concaved from the end surface, and meets a relationship of (R1+h2)/h2<μ1,
where h2 is a depth of the second portion from the end surface, R1 is a radius of the second portion, and μ1 is a relative permeability of the magnetic substance portion.

8. The developing apparatus according to claim 3, wherein the second portion is full-orbed in plan view, concaved from the end surface, and meets a relationship of R1>r and h2>r,
where h2 is a depth of the second portion from the end surface, R1 is a radius of the second portion, and r is an average radius of the carrier.

9. The developing apparatus according to claim 5, wherein the second portion is full-orbed in plan view, concaved from the end surface, and meets a relationship of R1>r and h2>r,
where h2 is a depth of the second portion from the end surface, R1 is a radius of the second portion, and r is an average radius of the carrier.

10. The developing apparatus according to claim 1, wherein a relationship of Sa>0.3×S is met, where Sa is an area of the second portion in plan view and S is an area of the magnetic substance portion in plan view.

11. The developing apparatus according to claim 4, wherein a relationship of Sa>0.3×S is met, where Sa is an area of the second portion in plan view and S is an area of the magnetic substance portion in plan view.

12. The developing apparatus according to claim 1, wherein the magnetic substance portion is formed of a material whose magnetic permeability is greater than magnetic permeability of the carrier.

13. The developing apparatus according to claim 3, wherein the magnetic substance portion is formed of a material whose magnetic permeability is greater than magnetic permeability of the carrier.

14. The developing apparatus according to claim 1, wherein the plurality of magnetic substance portions is disposed at equal intervals.

15. The developing apparatus according to claim 3, wherein the plurality of magnetic substance portions is disposed at equal intervals.

16. The developing apparatus according to claim 1, wherein a relationship of L>0.5R is met, where L is a distance between adjacent magnetic substance portions and R is a radius of the magnetic substance portion.

17. The developing apparatus according to claim 3, wherein a relationship of L>0.5R is met, where L is a distance between adjacent magnetic substance portions and R is a radius of the magnetic substance portion.
